(19) United States
(12) Patent Application Publication
(10) Pub. No.: US 2025/0348457 A1
(43) Pub. Date: Nov. 13, 2025

(54) REINFORCEMENT LEARNING SYSTEM AND METHOD WITH REGION-AWARENESS AND SHARED PATH EXPERIENCE IN NETWORKS-ON-CHIP

(71) Applicant: COLORADO STATE UNIVERSITY RESEARCH FOUNDATION, Fort Collins, CO (US)

(72) Inventors: Sudeep PASRICHA, Fort Collins, CO (US); Kamil KHAN, Fort Collins, CO (US)

(21) Appl. No.: 19/204,101

(22) Filed: May 9, 2025

Related U.S. Application Data
(60) Provisional application No. 63/644,630, filed on May 9, 2024.

(51) Int. Cl. G06F 15/78; G06N 20/00

(52) U.S. Cl. CPC G06F 15/7825; G06N 20/00

(57) ABSTRACT

Network-on-chip (NoC) employing reinforcement learning (RL) operation (e.g., Q-routing) implemented in, or in part in, the routing elements of the NoC to improve the routing of data in the NoC using region-aware function and path-aware cost function, as estimates of congestion, that account for region contention, path contention, or a combination thereof. The routing elements beneficially consider the cost of a packet's remaining journey, which can improve local and global routing. The reinforcement learning agent at each router performs an update operation to share the global and regional congestion information with local neighbors.

### RELATED APPLICATION

This U.S. application claims priority to, and the benefit of, U.S. Provisional Patent Application No. 63/644,630, filed May 9, 2024, entitled “Reinforcement Learning Framework with Region-Awareness and Shared Path Experience for Efficient Routing in Networks-on-Chip,” which is incorporated by reference herein in its entirety.

### BACKGROUND

Distributed or parallel systems are being deployed as requirements continue to grow for more computation density. In these systems, a number of processing elements can be connected by an interconnecting network, e.g., a network fabric. Network-on-chip (NoC) systems are one example of such distributed and parallel systems and can overcome data movement bottlenecks as chips are designed with more cores, e.g., to provide a scalable, high-performance, and reliable interconnection fabric for manycore and heterogenous system-on-chip (SoC). NoCs can be designed with routing elements that form the interconnecting network, e.g., as a network fabric over optical or electrical connections. Similar to networking technology, NoCs are typically designed to route packets among routing elements using routing policies to determine the paths that network packets may take.

NoC allows predictable timing characteristics using structured wiring so IP and chip designers can have reliable timing information. However, exploiting the structured wiring interconnect introduces challenges associated with having to route information through a network fabric. There is a benefit to improving the routing of NoC systems.

### SUMMARY

An exemplary system and method are disclosed for a network-on-chip (NoC) that employs reinforcement learning (RL) operation (e.g., Q-routing) implemented in, or in part in, the routing elements of the NoC to improve the routing of data (e.g., flits) in the NoC using region-aware function and path-aware cost function, as estimates of congestion, that account for region contention, path contention, or a combination thereof. The routing elements of the exemplary NoC beneficially consider the cost of a packet's remaining journey, which can improve local and global routing. The reinforcement learning agent at each router performs an update operation to share the global and regional congestion information with local neighbors. To this end, the number of Q-learning packets and communications can be kept to a minimum, and the implementation can introduce minimal overhead.

The exemplary Q-routing is configured to use estimates of congestion to select the best route from any source to any destination, in which the estimates of congestion are represented by a Q-value determined as a sum of estimated congestion or delay in the selection of a nearby neighbor and each likely hop to a destination router. The Q-value in the routing table thus provides, via a single number, an indication of global estimated congestion and delays among regions though is reduced down to a selection of a single neighbor (in that the routing will produce a likely routing effect but does not explicitly define a route or a set of neighbors). Routing based on the Q-value can provide the selection of neighbors along a lower contention cost and region contention cost, as aggregated along a path associated with that lower cost. The Q-routing policy would be maintained at each respective router and represented by the routing table (Q-routing table), having a set of Q-values that each provides an estimation of congestion for a path to a destination.

In some embodiments, to further improve the operation of the Q-learning and Q-learning updates, the routers (e.g., via the RL agent) additionally share path experience updates and maintain direction values in the routing tables and direction values encoding a route indicator, to neighboring routers, between packet flows to different destinations that share the same route portions. Examples of a route indicator can be “north-to-south”, “north-to-east”, “west-to-south,” and the like.

The shared path experience operation extends the routing table in each router by a column to remember the routes taken by packet flows to each destination. The route through a router may be denoted by the pair (Input Port, Output Port), and represented using integer values. When a packet destined to (destination) node is sent from a router to neighbor node, the neighbor node can send back the Q-values and sum cost for the destination, and additionally, because of the shared experience, the Q-values and sum cost for each destination node having the same shared path experience value in the router table. In this way, the experience from a single packet flow can be used to update the policy for multiple flows sharing the same route through a router.

A study was conducted that evaluated the exemplary system and method against a state-of-the-art Q-routing-based system. An example implementation of the exemplary system and method was observed to improve the average packet latency by 18.3% and reduce NoC energy consumption by 6.7%, with minimal area overheads as compared to other state-of-the-art NoC systems and methods that do not employ (i) path contention and regional congestion consideration in their cost function nor (ii) capability of sharing experiences.

In an aspect, a network-on-chip (NoC) is disclosed having a plurality of cores and a plurality of routers forming a fabric to connect the plurality of cores, the network-on-chip comprising: at all or a substantial set of the plurality of routers, each router of the all or subset comprising: a port having one or more input channels and one or more output channels; a routing table (e.g., Q-routing table) configured to store a set of one or more Q-values each associated with an estimated congestion or delay cost for a network packet to traverse a flow defined between a neighbor router and a destination router, wherein the Q-values are determined from Q-values aggregated along all or a portion of the flow; and a router processor unit having instructions stored thereon, wherein execution of the instructions causes the router processor unit to: receive via the one or more input channels a network packet from another router in the NOC or generate a network packet from data received from a core connected to the router; determine a route to send the network packet based on the set Q-values, wherein the determination is used to transmit the network packet along the flow to a subsequent router located downstream to the router; generate an update to at least one of the one or more Q-values using (i) a Q-value determined and stored at a respective routing table of a subsequent router, (ii) contention cost associated with congestion or occupied channels in a downstream router; and update the generated updated to a Q-value.

In some embodiments, the contention cost includes path contention cost defined by a number of occupied input channels and output channels determined for the subsequent router.

In some embodiments, the contention cost includes region contention cost determined as a sum of all valid port numbers of reserved output channels.

In some embodiments, the subsequent router and all subsequent routers (e.g., via RL agents executing there at) in the flow are configured to determine an updated Q-value; and update via a reinforcement learning operation one or more Q-values based on data received from a subsequent router to the each respective router.

In some embodiments, the update to the Q-value employs Q-value determined and stored at a respective routing table of a subsequent router, and the contention cost associated with congestion or occupied channels in a downstream router.

In some embodiments, the occupied channels in a downstream router is a determined as a number of occupied input and output channels determined and stored in a channel reservation table of the subsequent router.

In some embodiments, the update to the Q-value is performed in the router processor unit.

In some embodiments, the operation to generate the update to the at least one of the one or more Q-values is performed using a reinforcement agent executing in each router of the NoC.

In some embodiments, the update to the Q-value is performed in part by the router processor unit and in part by a core operatively coupled to the router processor unit.

In some embodiments, the routing table of the subsequent router maintains a route indicator to a respective destination router having a previously reached prior packet transmission.

In some embodiments, the route indicator is an integer or encoded value representing a direction of a flow of the network packet to a port associated with the respective destination router.

In some embodiments, the subsequent router is configured to additionally transmit (i) Q-values determined and stored at a respective routing table of other routers based on the route indicator and (ii) contention cost associated with congestion or occupied channels in a downstream router.

In some embodiments,, the path contention cost is determined using a path contention cost circuit implemented in the router, the path contention cost circuit comprising at least one of: a comparator and adder configured to increment a partial sum for a total number of occupied input VCs and reserved output VC.

In some embodiments, the region contention cost is determined using a region contention cost circuit implemented in the router, the region contention cost circuit comprising an adder configured to add the number of reserved VCs in the outputs other than the selected output downstream routers to the subsequent router.

In another aspect, a method is disclosed comprising: receiving data packet at a first router in a network-on-chip (NoC) having a plurality of cores and a plurality of routers forming a fabric to connect the plurality of cores; determining a route between two or more neighbor routers to send the data packet based on a set Q-values associated with estimated path contention and region contention cost determined for the data packet being sent to a given neighbor router; transmitting the data packet from the first router to a neighbor router based on the determination; receiving at the first router updated cost parameters associated with the estimated path contention and the region contention cost from the neighbor router; and updating at the first router one or more Q-values using updated cost parameters associated with the estimated path contention and the region contention cost from the neighbor router received from the neighbor router, wherein the updated Q-values are subsequently used to route subsequent data packet received at the first router.

In some embodiments, the set Q-values associated with estimated path contention and region contention cost are maintained in a Q-routing table.

In some embodiments, the subsequent router is configured to receive the data packet and determine a route between two or more of its neighbor routers to send the data packet based on a set Q-values associated with estimated path contention and region contention cost determined for the data packet being sent to its neighboring routers, and the subsequent router is configured to (i) receive updated cost parameters associated with the estimated path contention and the region contention cost from its neighbor router and (ii) update one or more Q-values of its Q-routing table using the updated cost parameters associated with the estimated path contention and the region contention cost received from its neighbor router.

In some embodiments, the subsequent router is configured to perform a shared path experience operation that additionally transmits (i) Q-values determined and stored at a respective routing table of other routers based on the route indicator and (ii) contention cost associated with congestion or occupied channels in a downstream router.

In some embodiments, the subsequent router is configured to update the route indicator in the routing table based on flow of other data packets.

In another aspect, a system is disclosed comprising: a plurality of cores and a plurality of routers, wherein all or a substantial set of the plurality of routers comprises: a port having one or more input channels and one or more output channels; a routing table (e.g., Q-routing table) configured to store a set of one or more Q-values each associated with an estimated congestion or delay cost for a network packet to traverse a flow defined between a neighbor router and a destination router, wherein the Q-values are determined from Q-values aggregated along all or a portion of the flow; and a router processor unit having instructions stored thereon, wherein execution of the instructions causes the router processor unit to: receive via the one or more input channels a network packet from another router in the NOC or generate a network packet from data received from a core connected to the router; determine a route to send the network packet based on the set Q-values, wherein the determination is used to transmit the network packet along the flow to a subsequent router located downstream to the router; generate an update to at least one of the one or more Q-values using (i) a Q-value determined and stored at a respective routing table of a subsequent router, (ii) contention cost associated with congestion or occupied channels in a downstream router; and update the generated updated to a Q-value.

### BRIEF DESCRIPTION OF DRAWINGS

FIGS. 1A-1C each shows an example network-on-chip (NOC) system having a plurality of routers each configured for region-aware reinforcement learning based routing, in accordance with an illustrative embodiment.

FIGS. 2A-2E shows example operations for region-aware reinforcement learning based routing and learning in accordance with an illustrative embodiment.

FIGS. 3A-3C shows example operations for shared path experience update in accordance with an illustrative embodiment.

FIGS. 4A-4C show an experimental setup for the exemplary system and a comparison between the exemplary system and other state-of-the-art systems.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

### Example System

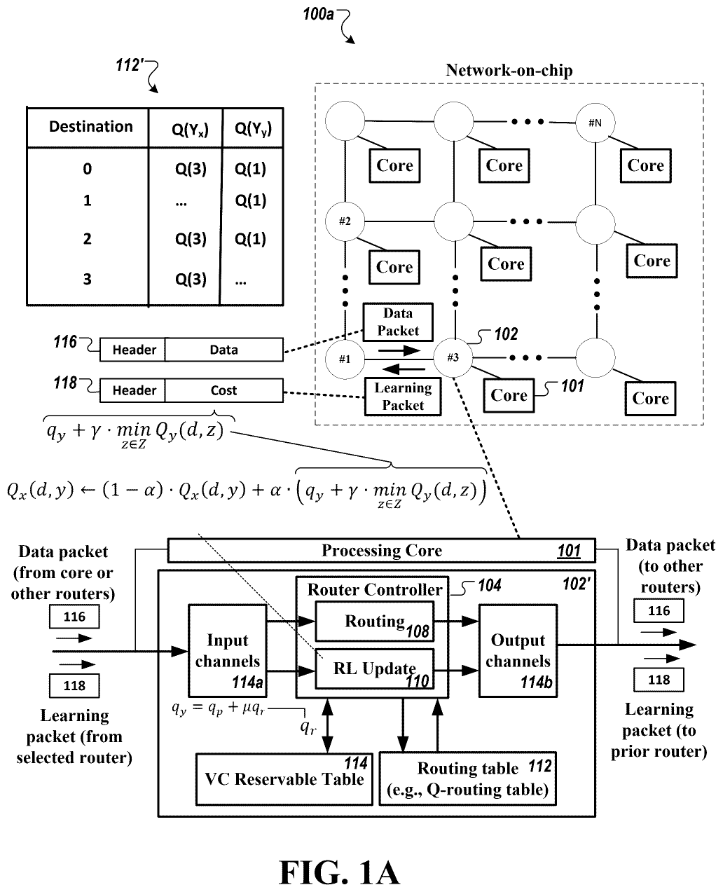

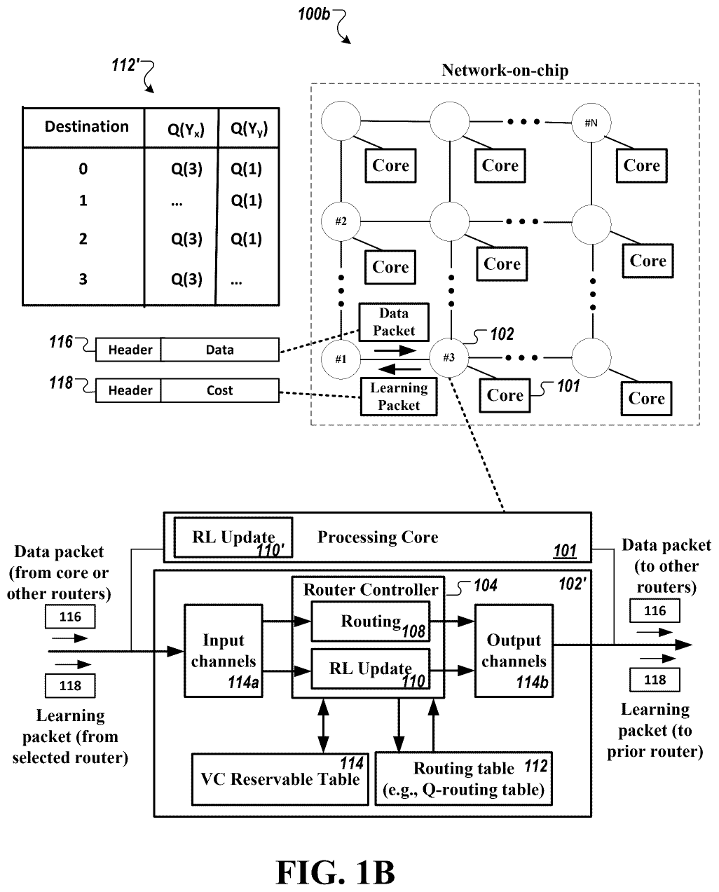

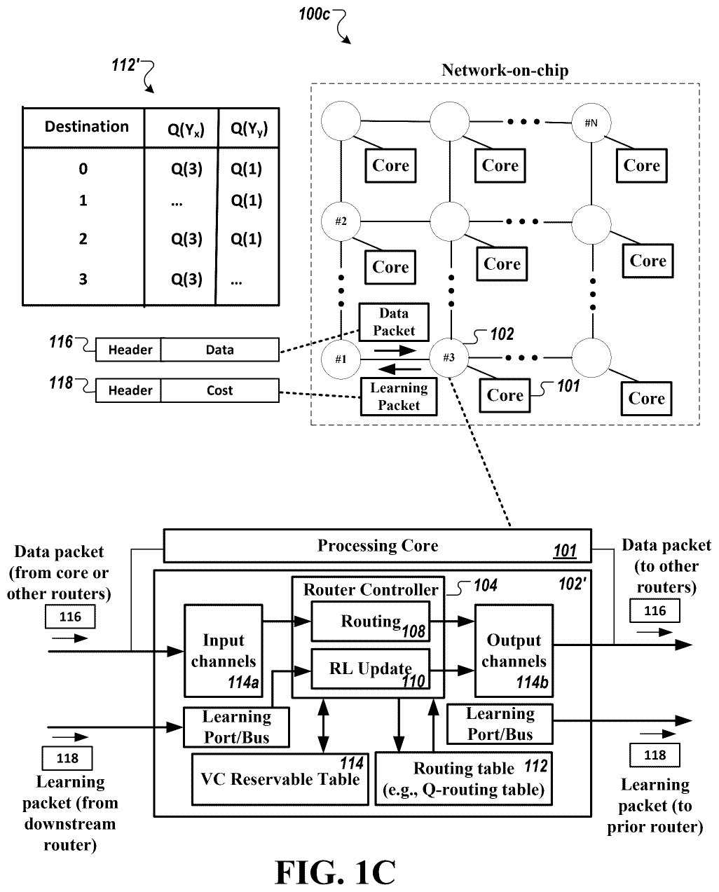

FIGS. 1A-1C each shows an example network-on-chip (NOC) system 100 (shown as 100a, 100b, 100c) having a plurality of routers each configured for region-aware reinforcement learning based routing, in accordance with an illustrative embodiment. In FIG. 1A and 1B, the example network-on-chip (NOC) system (100a, 100b, 100c) has a plurality of cores 101 (e.g., #1, #2, etc.) and a plurality of routers 102 (e.g., #1, #2, #3, . . . , #N) forming a fabric. At all or a substantial set of the plurality of routers 102, each router 102 (shown as 102′) includes a router controller 104 having a routing circuit 108 and a reinforcement learning module 110 (shown as “RL update” 110), e.g., executing a RL agent). The router 102 includes a Q-routing table 112 and virtual channel reservation table 114. Each router has one or more physical ports (not shown) having a plurality of input virtual channels (shown as 114a) and plurality of output virtual channels (shown as 114b). The virtual channels (114a, 114b) allow the router and associated Q-learning operation to quantify congestion and availability of routers in various regions of the NoC for region-aware reinforcement learning based routing.

The NoC (e.g., 100a, 100b, 100c) may be a structured wired NoC having a plurality of cores and routers 102 forming a structure fabric or may be other NoC, e.g., referenced or described herein.

Router Controller. The router controller 104 is operatively connected to the router port having the VC input and outputs (e.g., 114a, 114b) and configured, via the routing module 108, to determine a route to send the data packet 116 based on a set of Q-values associated with an estimated congestion or delay assigned to a destination router that is stored and maintained in the Q-routing table 110. Q-values can be considered as representing the sum of discounted costs from the current router to the destination. The router controller 104 (e.g., implementing an RL agent), via the RL update 110, is also configured to generate a learning packet 118 having Q-learning update.

Region-Aware Q-Routing. The routing module 108 is connected to a Q-routing table 112 and includes circuits to select a table element, e.g., having a lowest table value, to select a port or port virtual channel for routing to a next router. Q-routing table 112 (shown as 112′) includes a set of rows for each destination location and a set of columns having Q-values. Two or more columns may be included: one for each direction of routing. For a NoC having a grid structured wiring in which each router is connected to 4 other routers, the Q-routing table 112 may be configured with 2 columns that each store a Q-value associated with a horizonal direction routing and a vertical direction routing. In such example, the routing module 108 is configured to select between a Q-value for a horizonal router (Q(Yₓ)) or a Q-value for a vertical router (Q(Y_{y})).

Rather than table values indicating delays, the Q-routing table 110 includes columns to Q-values that each indicates an estimate of congestion for a selectable neighbor. In some embodiments, the Q-value is a sum of estimated congestion or delay in the selection of a nearby neighbor and each likely hop to a destination router. The Q-value in the routing table thus provides, via a single number, an indication of global estimated congestion and delays among regions though is reduced down to a selection of a single neighbor. Routing based on the Q-value can provide the selection of neighbors along a lower contention cost and region contention cost, as aggregated along a path associated with that lower cost.

Q-values may be calculated at a prior cycle to the current transmission cycle using (i) a measure of input port contention with output port contention at the neighboring router and (ii) a measure of region contention cost as the sum of contention among output ports of neighboring routers. The definition of cost can be integral here to the Q-routing policy. To account for downstream congestion along multiple associated routers for that path, region-aware Q-routing can employ (i) the measure of input port contention with output port contention at the neighboring router and (ii) the measure of region contention cost as the sum of contention for all possible output ports.

Path contention cost. In an example implementation, the path contention cost qₚ, can be calculated per Equation 1.

$${q}_{p} = {r}_{i} + {r}_{o} \qquad ( Eq . 1 )$$

In Equation 1, rᵢ is the number of occupied VCs at the input, and rₒ is the number of reserved VCs at the output port, of a given neighboring router. The packet's latency (i.e., congestion) can be affected by contention at the input port and contention at the output port of a neighboring and downstream routers. Information about the output port contention (e.g., the number of reserved VCs) may be available from the VC reservation table.

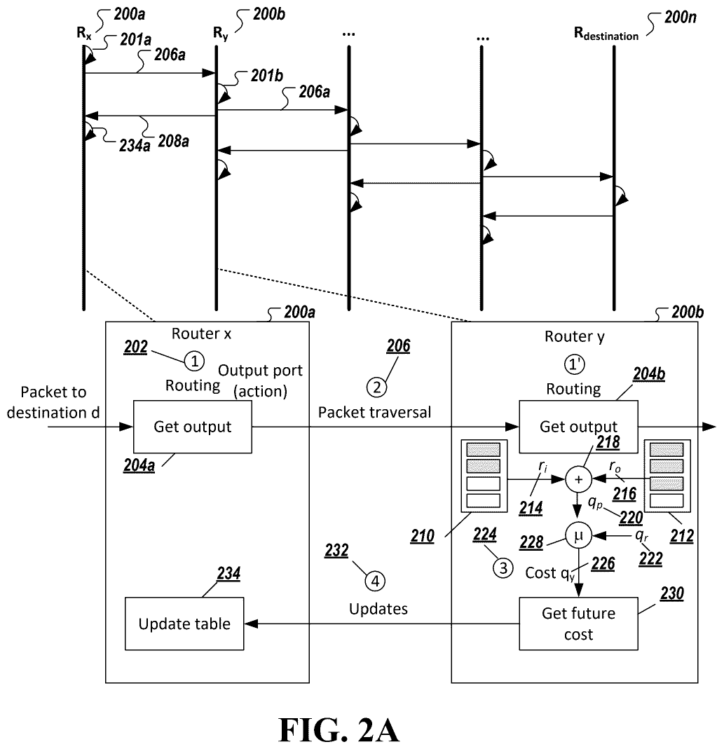

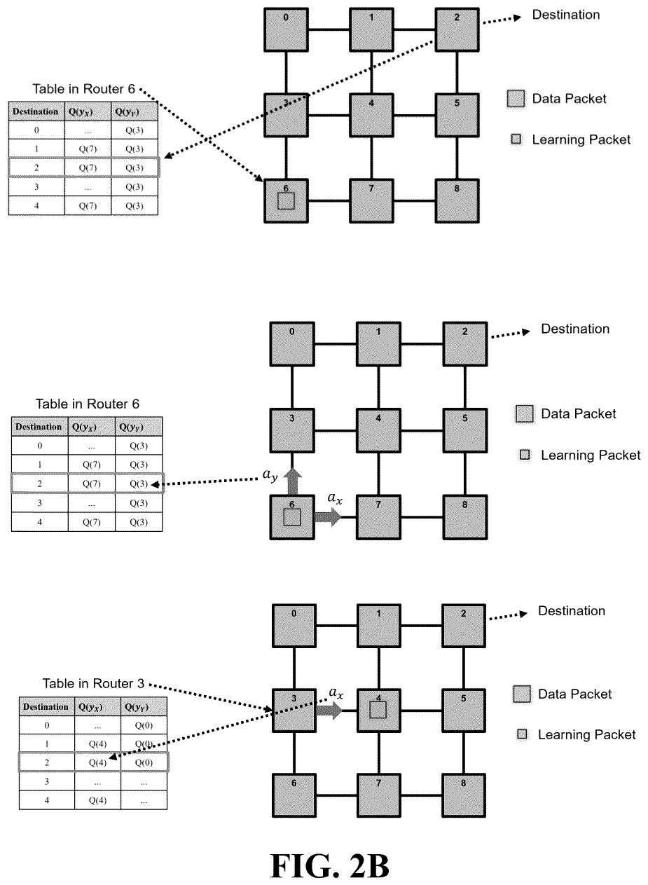

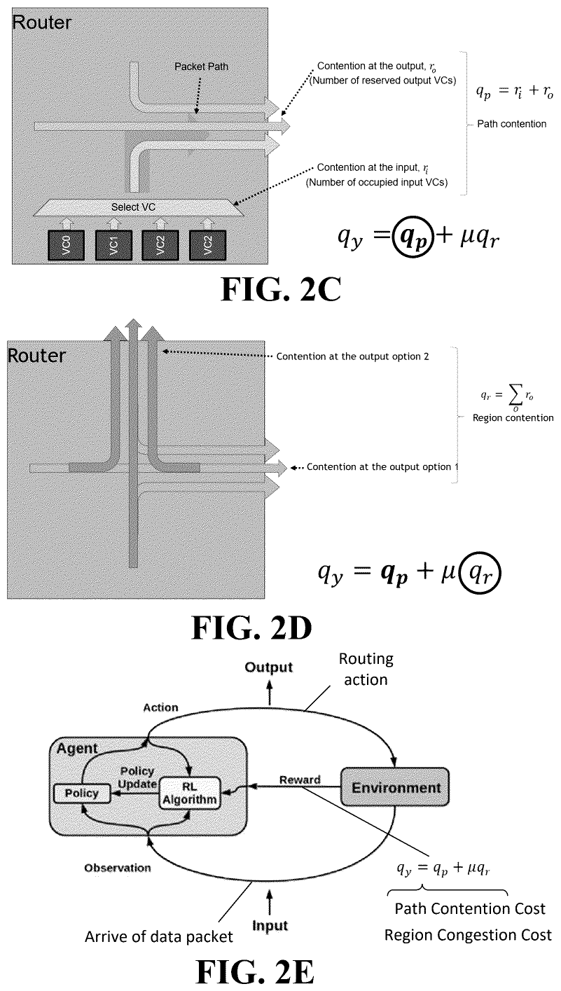

FIG. 2C shows (i) example contention costs at input and output channels of a router and (ii) an example path contention cost of the router defined using the contention costs at input and output channels.

To improve the network operation and reduce the number of hop latencies to estimate by one, the router controller 104 may be configured to use a Q-value determined using information provided from the down-stream router instead of a Q-value calculated using information available only at the current router. If calculating Q-value at the current router, the Q-value would be subject additional delayed cost such as packet latency in the input queue of the downstream router, which can cause a delay in the update after a routing action has been taken. This is because the packet latency is only available after the data packet has traversed the downstream router. A delayed update can reduce the ability of the router controller and its policy to adapt quickly to the network condition. To avoid the delay associated with latency, the cost can be derived from the input buffer/virtual channel (VC) utilization of the down-stream router immediately after the packet enters the neighboring router and then provided to the upstream router. The input buffer utilization is thus implementation that can represent contention at the input port of the downstream router.

Region congestion cost. Cost of region congestion qᵣ (also referred to as region contention cost qᵣ) may be additionally employed as cost for alternative paths which are not currently in use to influence the Q-values. In other words, region congestion cost can be path contention for paths in the region other than the presently chosen path. A regional component in the cost direct a policy that can find contention-free paths passing through less congested regions. Selecting paths passing through less congested regions can facilitate nearby optimal route when some parts of the path become congested.

The region contention cost qᵣ can be defined as the sum of contention for all possible output ports of router nodes, as shown in Equation 2.

$${q}_{γ} = {\sum }_{O} {r}_{o} \qquad ( Eq . 2 )$$

In Equation 2, qᵣ is region contention cost, O is the set of all routing options, and rₒ is the number of reserved VCs in the output direction o.

FIG. 2D shows (i) example contention costs at output channels of a router and (ii) an example region contention cost of the router defined using the contention costs at output channels.

Q-value Calculation. Using Equations 1 and 2, the total cost q_{y} can be computed and re-computed, e.g., per each cycle, per Equation 3. In equation, the region contention cost qᵣ is considered using a weighted sum of the path and region contention cost components.

$${q}_{y} = {q}_{p} + μ {q}_{r} \qquad ( Eq . 3 )$$

In Equation 3, μ∈[0, 1] and is used for assigning priority to the region cost component. In other embodiments, the path and region contention cost components can be weighted equally, and q_{y}=qₚ+qᵣ.

Each Q-value for a given destination Qₓ(d, y) as employed in Q-routing table 110 can be determined, and updated, per Equation 4.

$${Q}_{x} ( d , y ) ← ( 1 - α ) \cdot {Q}_{x} ( d , y ) + α \cdot ( {q}_{y} + γ \cdot {min}_{z ∈ Z} {Q}_{y} ( d , z ) ) \qquad ( Eq . 4 )$$

In Equation 4, Qₓ(d, y) can be considered as denoting the cost associated with estimated latency, time, congestion to send a data packet from router x to destination d through the neighboring router y, a is the learning rate of the Q-learning model, γ is the discount factor. When router x selects neighbor y as the next hop, node y send back its own estimate of minimum latency for the packet's remaining journey

$${min}_{z ∈ Z} {Q}_{y} ( d , z ) ,$$

where Z is the set of all valid neighbours of y. Put another way, the learning rate determines the weight of new updates as the rate of change of routing policy. The discount factor determines the weight of estimated future cost compared to the immediate cost in each update. This defines the importance of later routing actions.

The term

$${}^{‶} {q}_{y} + γ \cdot {min}_{z ∈ Z} {{Q}_{y} ( d , z )}^{″}$$

may provided by the downstream router for the update at the current router x. The term

$${}^{‶} {q}_{y} + γ \cdot {min}_{z ∈ Z} {{Q}_{y} ( d , z )}^{″}$$

may be fed back from a neighbor router to the transmitting router using a single-flit learning packet. In some embodiments, the term

$$“ {q}_{y} + γ \cdot {min}_{z ∈ Z} {Q}_{y} ( d , z ) ”$$

is a scalar value determined at the downstream router.

Router x then updates the Q-value Qₓ(d, y) using, e.g., the time the packet spends in the router x's local queue, qₓ and the estimate from node y, e.g., per Equation 4. The discount factor γ may be used to adjust the weight of the congestion estimate for the remaining path in the update. Similarly, the learning rate a may be used to assign weight to new experiences. Cost Qₓ is a Q-routing design choice and can be redefined to include other costs. In addition, Cost Qₓ can be configured in other form.

In Q-routing, the state, s is defined as the location of the packet being routed (i.e., the local router) and the packet's destination. In the selection stage of routing, the direction of the output port selected at each hop can be denoted as the action, a. After the packet reaches the downstream router, the downstream router transmits a learning packet back to the local router with its own estimate of the remaining cost until the packet reaches its destination. The estimate of the remaining cost and the immediate cost of selecting action a (experience) is used to update the Q-routing policy to reinforce actions which reduce total packet latency from the source to the destination.

The Q-routing policy can be stored in a distributed manner in the form of tables inside routers. The table in each router stores Q-values, which each represents the estimated latency to each destination node for each output port available for selection. Table 1 shows an example table from a node's router (e.g., node 8) in an example 8×8 mesh NoC. FIG. 2B shows an illustration of the same.

TABLE 1

| | | Q-Values |
|---|---|---|
| Destination (d) | Neighbors (y) | (Q₆(d, y)) |

| | | | | |
|---|---|---|---|---|
| Node 2 | Node 0 | Node 1 | Q₆(2, 0) | Q₆(2, 1) |
| Node 3 | Node 0 | Node 1 | Q₆(3, 0) | Q₆(3, 1) |

In Table 1, when node 6 sends a packet to node 2 through neighbor node 3, the Q-value for the routing action Q₆(2, 3) can be updated using Equation 4. Upon receiving the packet from node 6, node 3 can send back its own estimate for the packet's remaining journey, i.e., Q₃(2, 0), assuming node 3 selects its neighbor node 0 as the next node. Next, the weighted sum of the latency in node 6's router qₓ and the estimate Q₃(2, 0) can be used to update Q₆(2, 3) in the Q-routing table (e.g., 110) of Router x using Equation 4. At each hop, the router follows the minimum selection rule, i.e., the router selects the action with the lowest Q-value to minimize total packet latency.

The Q-routing tables (e.g., 110) with Q-values and the minimum selection rule can facilitate the selection of the path with the minimum expected total latency to every destination from every node in the network. By selecting the neighbor with the minimum expected latency, a Q-routing policy can minimize the total accumulated cost of its routing actions. In Equation 4, the cost Qₓ can been defined as the queue latency of the packet in the local router, and when defined as such, the Q-values in each router converge to the total latency (cost) from the current router to the destination. Since the Q-values determine the routing policy, the choice of cost function is central to the Q-routing policy. The cost function can be flexible and redefined to represent goals different than minimizing latency, e.g., minimizing transmission power, controlling router temperature, etc. As packets are routed using Q-routing, the path with the least total cost to each destination can be learned using experience from packets going to the same destination.

Q-Learning Discussion. Q-learning is often considered as a model-free learning algorithm for solving reinforcement learning (RL) problems that does not require a model of the environment to learn a policy. In RL (e.g., FIG. 2E), an agent learns to maximize the return or long-term reward over a sequence of actions in an environment. The agent has a representation of the current environment state, s. At each step t, the agent takes an action aₜ in state sₜ. The action transitions the agent state from sₜ to the next state, sₜ₊₁. At step t+1, the agent also receives a scalar reward for the action aₜ, which is used by a learning algorithm (e.g., Q-learning) to update the current agent policy.

In Q-learning, an agent uses the state-value function Q(sₜ, aₜ) to estimate the expected return of an action aₜ in state sₜ. As each step t, the policy can be updated using Equation 5.

$${Q}^{n e w} ( {s}_{t} , {a}_{t} ) ← ( 1 - α ) \cdot Q ( {s}_{t} , {a}_{t} ) + α \cdot ( {r}_{t} + γ \cdot {max}_{a ∈ A} Q ( {s}_{t + 1} , a ) ) \qquad ( Eq . 5 )$$

In Equation 5, a is the learning rate, rₜ is the reward for action aₜ in state sₜ, γ is the discount factor, and

$${max}_{a ∈ A} Q ( {s}_{t + 1} , a )$$

is the expected return for choosing the best action at state sₜ₊₁ from the set of all actions a. In the exemplary system, the expected return is shown formulated as a cumulative reward, e.g., determined by minimizing cost

$$( {min}_{z ∈ Z} {Q}_{y} ( d , z ) )$$

### per Equation 4.

The learning rate specifies the weight of new experience compared to the existing estimate. The reward rₜ is a scalar value representing the consequence of taking action aₜ at sₜ. γ∈[0,1] is the discount factor that determines the importance of future rewards. With a discount factor (γ) of 0, the agent may consider only current rewards, represented by rₜ in Equation 5. Conversely, as γ approaches 1, the agent may consider future rewards equally.

The function Q(s, a) can be represented using a Q-table. The Q-table can store the expected return of each state-action pair as Q-values Q (sₜ, aₜ).

Q-routing (e.g., as employed by systems 100a, 100b, 100c) applies the RL framework to the problem of routing in NoCs using Q-learning. Typically, the objective is to learn a routing policy which can minimize packet latency by adapting to the network condition online. In Q-routing, the state, s is defined as the location of the packet being routed (i.e., the local router) and the packet's destination. In the selection stage of routing, the direction of the output port selected at each hop is denoted as the action, a.

### Example Routing and Q-learning Operation

FIG. 2A shows an example operation and configuration of the NoC routers to perform region-aware reinforcement learning based routing and associated reinforcement learning updates in accordance with an illustrative embodiment. FIG. 2B shows an example of an operation performed in FIG. 2A.

In FIG. 2A, a packet is shown being transmitted through Router x (200a), Router y (200b) to a destination at Router destination (200n). Operations are shown across a set of routers between Router x (200a) and the destination, Router_{destination} (200n). Detailed operations for two neighboring routers (200a, 200b) are shown where each is configured to perform the routing, packet traversal, and cost calculation.

To transmit a packet to destination y (200n) through the neighboring routers (e.g., 200a, 200b), Router x (200a) first performs a routing operation (201, shown as 201a) using its routing table (Q-table) (shown as “Get output” 204a) and selects Router y (200b) to transmit (206, shown as 206a) the packet to Router y (200b). Router y (200b) receives the transmitted packet and similarly performs a routing operation (201, shown as 201b) using its routing table (Q-table) (shown as “Get output” 204b) to transmit (206, shown as 206b) the packet to a next router along the path to the destination y. Router y (200b) is then shown configured to calculate (also shown as 206b) an update cost to be sent back (208, shown as 208a) a learning packet to the prior transmitted router, namely Router x (200a).

In the example shown in FIG. 2A, the path contention cost is calculated (e.g., via a RL agent executing at Router y (200b)) using two sets of comparators: a first to check if input virtual channels (210) are occupied and a second to check the reservation status of the output virtual channels (212). The outputs of the comparators are used to increment (i) the partial sums rᵢ (214) as the total number of occupied input VCs, and (ii) the total number of reserved output VCs rₒ (216). The reinforcement learning agent then combines (218) the partial sum rᵢ (214) and the total number of reserved output rₒ (216) to generate a total path contention cost qₚ (220). In some embodiments, the reinforcement learning agent employs an adder operator (e.g., a 4-bit adder) to calculate the sum of the partial sum rᵢ and the reserved output rₒ. Other equivalent operators may be used.

The reinforcement learning agent then determines the second component of the cost function, namely the region contention cost qᵣ (222), e.g., by adding the number of reserved VCs in the outputs other than the selected output o to the total path contention cost qₚ.

The reinforcement learning agent then combines (224) the path contention cost qₚ (220) and region contention cost qᵣ (222) to generate a weighted sum q_{y} (226) of the cost functions. In some embodiments, the reinforcement learning agent employs a 4×4 multiplier (228) having the weight μ, as shown in Equation 3. Other equivalent operators may be used.

The reinforcement learning agent may determine (230) the future cost as

$${min}_{z ∈ Z} {Q}_{y} ( d , z )$$

then writes the cost q_{y} and determined future cost into a learning packet to be used in the update (232) to Router x (200a) and then transmit the learning packet to Router x (200a). Router x (200a) receives the learning packet and performs an update (234, shown as 234a) at its routing table (Q-table).

In some embodiments, to avoid contention with the data packet, the NoC may implement a separate dedicated link to transmit learning packets (e.g., NoC 100c of FIG. 1C). In some embodiments, the reinforcement learning agent may employ same fabric for the learning packet transmission. As shown in FIG. 2A, the Q-learning update is performed in specialized hardware in the router.

Alternatively, and as shown in FIG. 1B, the reinforcement learning agent may be implemented in part (shown as “RL update” 110′) in a processing element (e.g., core) associated with the router. The reinforcement learning agent in the processing element, in such embodiments, may be configured to perform the future cost calculation.

Similar operations may be performed at each router and neighboring router pairs until the packet reaches the destination node (200n).

Shared path experience update. For implementing the modified table with the shared path experience update mechanism, the routing table may include an additional column for storing indicator information of the route taken by each packet flow. The total number of possible routes can be determined by the number of input and output channels for each packet flow. For example, when using minimal-route Q-routing, the route for any destination would have a maximum of two input and two output options, resulting in 4 total route options. Therefore, an additional 3 bits of information may be added to each row to track routes for each destination.

Alternatively, the choice of cost function can reduce the total number of bits required for the fixed-point representation of Q-values. For example, if queue latency is used as the cost, the Q-values represent the expected latency of the remaining journey of the packet. The upper limit for total latency can be large under high traffic loads, requiring more integer bits to represent the whole range.

The Q-values can be considered as representing the total number of packets competing for the remaining path in the region. The upper limit in this case may be a linear function of the number of nodes and channels in the network and may be smaller in most cases than the upper bound of latency. To this end, the reinforcement learning agent may employ a fixed-point representation with just 6 bits for the integer part and 4 bits for the fractional part. Other size and type representation may be used.

Once the additional updates are identified using the route information and written into learning packets, a buffer queue may be used to store them. In some embodiments, a queue size of 4 flits may be implemented to buffer 4 single-flit learning packets of size 8 bits. The queue size can be adjusted to trade off storage/transmission overheads and the rate of update.

### Example Shared Path Experience Update

To improve the operation of the Q-learning and Q-learning updates, the routers (e.g., via the RL agent) additionally share path experience updates and maintain direction values in the routing tables and direction values encoding a route indicator, to neighboring routers, between packet flows to different destinations that share the same route portions. The shared path experience operation extends the routing table in each router by a column to remember the routes taken by packet flows to each destination.

Frequency updates to the Q-values can improve and/or provide optimal Q-routing. In Q-routing, if packets to a destination d in router x have not used neighbor y recently, the Q-value for that router x Qₓ(d, y) may not be updated and continue to represent a prior state of the network. Share path experience can update, Qₓ(d, y) using the cost experienced by packets going to destinations other than d which uses the same route through the router y.

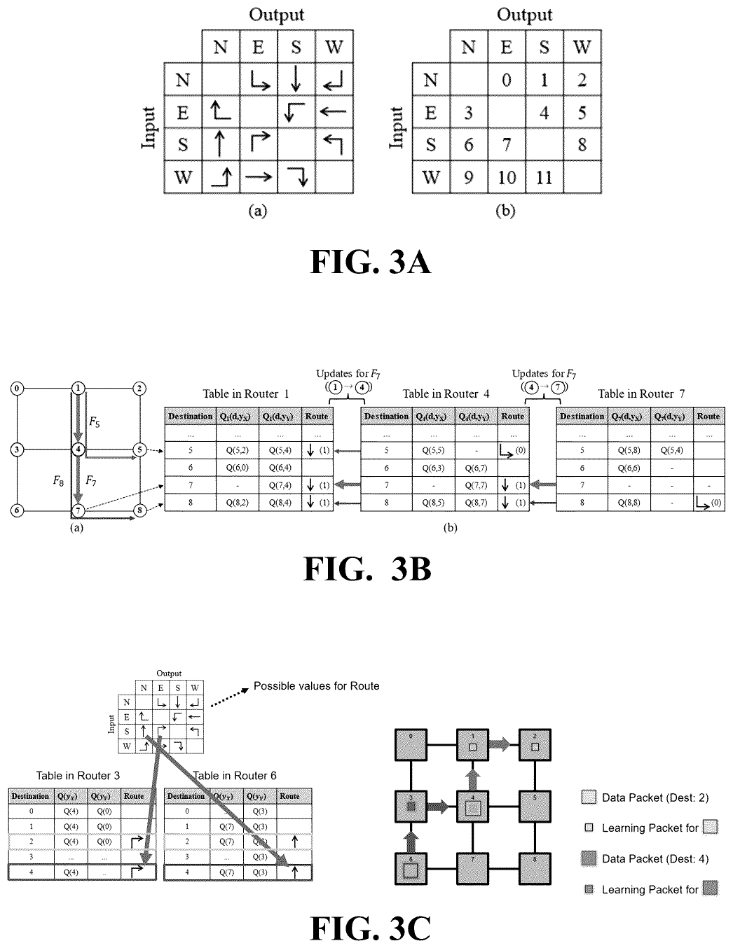

FIGS. 3A-3C shows example operations for shared path experience update in accordance with an illustrative embodiment.

FIG. 3A shows a diagram with all possible routes through a router in NoC (e.g., 2D-mesh NoC). Specifically, FIG. 3A, Subpanel (a) shows the routes as route arrows, and subpanel (b) shows the routes as route number values. As shown, a packet route can be defined by the input and output ports used by a packet in the router.

The exemplary system can employ the shared path experience update mechanism for NoC of any dimensions, including two-dimensional (e.g., a×b, a×a, b×b, b×a, etc.), three-dimensional (e.g., a×b×c, a×b×b, c×b×a, etc.), and higher-dimensional (e.g., 4D, 5D, etc.) NoC, wherein one or more traffic flows can be routed to any destination in any direction. FIGS. 5E-3C show an example shared experience update mechanism in a 3×3 2D-mesh NoC.

FIG. 3B subpanel (a) shows a 3×3 2D-mesh NoC with 9 nodes (i.e., routers) (e.g., nodes 0-9), where traffic flows F₅, F₈, and F₇. F₅ and F₈ have been routed (through some nodes) before F₇. As shown, traffic flow F₅ has been routed to destination node 5, F₈ to destination node 8, and F₇ is currently being routed to destination node 7. Packet of flow F₇ is routed northwards in two consecutive hops: first from node 1 to node 4, and then from node 4 to destination node 7. F₇ shares the first hop's route (↓) with both F₅ and F₈, and the second hop's route (↓) with F₈.

FIG. 3B subpanel (b) shows the tables of Q-values in routers 1, 4, and 7. For each destination, the table lists two Q-values, one for the neighbor in the horizontal direction, and another for the neighbor in the vertical direction y_{Y}. To achieve the minimal routing path to the destination, each node can have a maximum of two possible neighbors to choose from when routing in a 2D-mesh NoC (shown in FIG. 3B subpanel (a)). Therefore, each table of Q-values should have two columns of Q-values, one for each possible neighbor. Arrows between the rows in the tables can be used to represent the updates made to each table, as F₇ travels along the path 1∵4∵7. While the updates to the Q-values for node 7 are common in all Q-routing policies, the shared path experience update mechanism can provide additional updates to nodes 5 and 8 due to the shared paths between the flows. The update mechanism ensures that when packets belonging to flows F₅ and F₈ are routed in the future, the corresponding Q-values represent a more current state of the network congestion.

To use the additional updates, the table in each router can be extended by a column to remember the routes taken by packet flows to each destination. The route through a router can be denoted by the pair (Input Port, Output Port), and represented using integer values, as shown in FIG. 5D. In summary, when a packet destined to a (destination) node d is sent from a router x to a neighboring node y, node y may send back the Q-values Q_{y}(d, z) for destination d, as well as Q-value for Q_{y}(d′, z) for each destination d′ which has the same value in the router table's “Route” column as the packet being routed. In this way, the experience from a single packet flow can be used to update the policy for multiple flows sharing the same route through a router. Upon receiving the learning packet, the router x may use the cost q_{y} representing congestion at the router y and the Q-value estimates for all destinations to update the corresponding Q-values in its table using Equation 4.

### Experimental Results and Additional Examples

A study was conducted to develop and evaluate the exemplary reinforcement learning system and method (also referred to as “Q-RASP”) configured with (i) path- and region-awareness mechanism and (ii) shared path experience update mechanism, as described in relation to FIGS. 1-3.

Experimental Implementation. The study implemented a routing algorithm in logic implemented in each NoC router to calculate a new cost function (e.g., path-and region-aware cost function) and storing additional information in the routing table for the shared path experience update mechanism. The total cost for a routing action is the combination of the path contention cost and the region contention cost, as shown in Equation 1. The study used comparators, adders, and a multiplier alongside the existing input VCs and the reservation table to calculate the total cost. For the shared path experience update mechanism, the study stored route information for each packet flow to identify flows that shared the same route through the router.

To calculate the path contention cost, the study used two sets of comparators: one to check if input VCs were occupied and another to check the reservation status of the output VCs. The outputs of the comparators were incremented the partial sums rᵢ, the total number of occupied input VCs, and rₒ, the total number of reserved output VCs. Next, the study used a single 4-bit adder to output the total path contention cost qₚ as the sum of rᵢ and rₒ. The study found the second component of the cost, region contention cost qᵣ, by adding the number of reserved VCs in the outputs other than the selected output o to qₚ. The study combined the path contention cost and region contention cost into a weighted sum q_{y} by a 4×4 multiplier using the weight μ, as shown in Equation 3. Lastly, the study wrote the cost q_{y} into a learning packet with the estimate

$${min}_{z ∈ Z} {Q}_{y} ( d , z )$$

to be used in the update. For transmitting the learning packets, the study used dedicated links to avoid contention with data packets.

For implementing the modified table with the shared path experience update mechanism, the study extended the tables by one column for storing the route taken by each packet flow. The total number of possible routes can be determined by the number of input and output channels for each packet flow. For example, when using minimal-route Q-routing, the route for any destination has a maximum of two input and two output options, resulting in 4 total route options. Therefore, an additional 3 bits of information were added to each row to track routes for each destination. On the other hand, the choice of cost function can reduce the total number of bits required for the fixed-point representation of Q-values. For example, if queue latency is used as the cost, the Q-values represent the expected latency of the remaining journey of the packet. The upper limit for total latency can be large under high traffic loads, requiring more integer bits to represent the whole range. In the exemplary system, the Q-values represented the total number of packets competing for the remaining path in the region. The upper limit in this case was a linear function of the number of nodes and channels in the network and was smaller in most cases than the upper bound of latency. Therefore, the study used a fixed-point representation with just 6 bits for the integer part and 4 bits for the fractional part.

Once the additional updates were identified using the route information and written into learning packets, the study used a buffer queue to store them. In the experiment, the study chose a queue size of 4 flits to buffer 4 single-flit learning packets of size 8 bits [3]. The queue size can be adjusted to trade off storage/transmission overheads and the rate of update.

The study used partially-adaptive minimal-route Q-routing to avoid livelock and reduce the overhead of the routing table (e.g., Q-routing table) for storing Q-values by reducing the number of

routing actions. For deadlock freedom, partially-adaptive algorithms can employ turn-models [10], [11] to restrict some turns, avoiding packets waiting for each other in a cycle, which can cause a deadlock. In the exemplary system, the study split the available VCs into two sets, each with different turns restricted. In one set of VCs, south-first turns were restricted, whereas in the other set, north-first turns were restricted.

Experimental Setup. The study used the NoC simulator Noxim [12] to evaluate the performance of the exemplary reinforcement learning system and method in NoC routing. The study implemented the routing table (e.g., Q-routing table) and combinatorial logic for Q-learning in RTL, and synthesized the routing table using Cadence Genus to obtain power and area estimates. For estimating the area of the NoC router, the study used ORION 3.0 [13].

The study considered an 8×8 mesh NoC topology, utilizing a 45 nm technology node. Each node in the NoC comprised a processing element (PE) and a router. Each input port had 4 VCs with 4 flit buffers each, where each flit was 128 bits in size. The study used credit-based flow control, where the system operated at a clock frequency of 2 GHz and an associated operating voltage of 1 V. The table for storing Q-values had 63 rows, one for each destination, and 2 columns for Q-values for the horizontal and vertical directions. For the routing table and associated routing algorithm, the study included a fourth column to store route information of previous packet flows. Noxim was updated to use accurate energy estimates from the synthesized design to read and update the table for each Q-routing implementation.

For comparison, the study considered three different implementations of Q-routing in NoCs from previous studies [2], [3], [6], the local congestion-based adaptive routing policy DyAD [14], and the popular dimension order routing policy XY. QR [2] used the local queue latency of the packet as the cost for a routing decision, and QR did not use additional updates to the policy. BiLCQ [3] used the queue length of the downstream router as the cost, while using an additional update to the policy for every routing action. The additional update was applied to the packet flow in the reverse direction of the packet being routed. CrQ [6] also used a cost from the neighbor node like BiLCQ, except CrQ used the packet latency in the input queue. CrQ also used an additional table to implement a confidence-based learning rate for updating Q-values. DyAD [14] was an adaptive routing algorithm that used the current queue length of the neighbors to make routing decisions without using Q-learning. All prior Q-routing policies used a learning rate (1) of 0.50 and a discount factor (γ) of 1.

The routing policy (e.g., Q-routing policy) of the exemplary system used a higher learning rate of 0.70, and a lower discount factor of 0.90. The study increased the learning rate for faster convergence of Q-values and decreased the discount factor to facilitate the policy to switch to alternate paths faster. The regional cost factor μ was set to 0.1. The study evaluated these policies using the metrics of average network latency, total network energy consumption, and area.

Performance Results. The study used average NoC packet latency to evaluate the performance of the exemplary system. Packet latency was defined as the cycle duration from when the packet was injected into the NoC at the source node to when the packet was ejected at the destination node. The packet latency did not include the time spent in the injection queue. Using various synthetic traffic patterns, the study monitored packet latency with increasing injection rates.

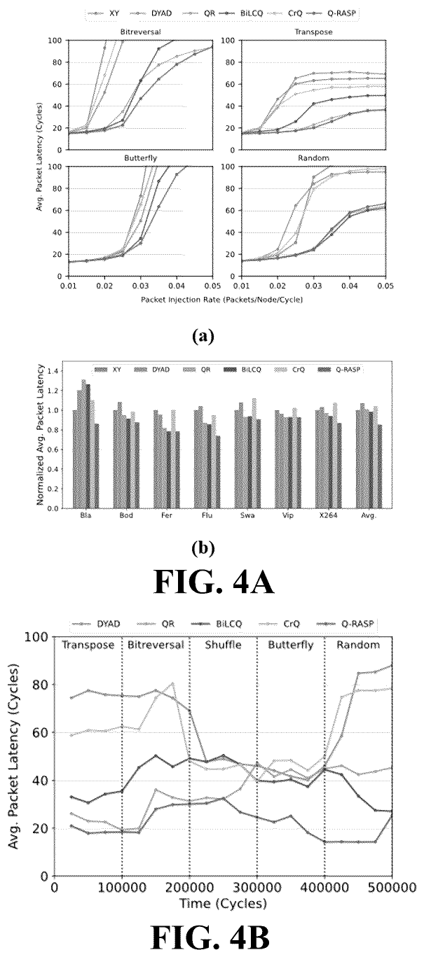

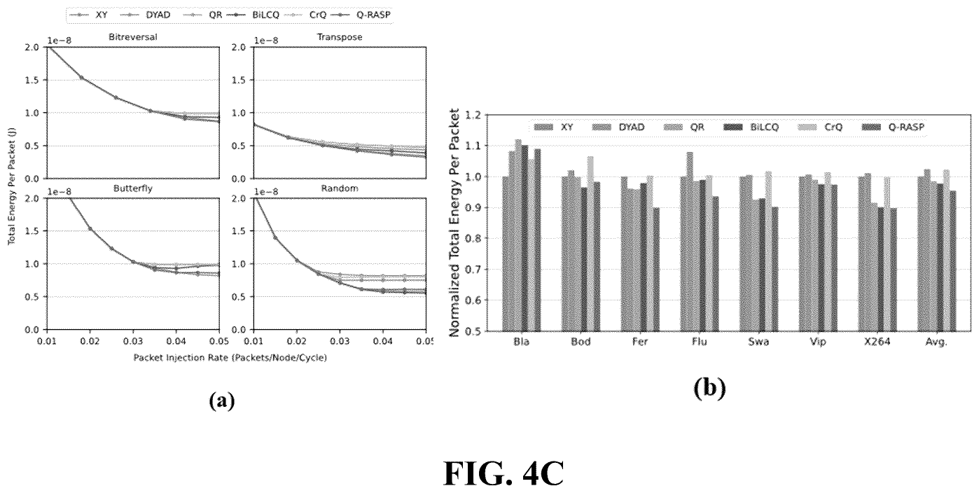

FIGS. 4A-4C show an experimental setup for the exemplary system and a comparison between the exemplary system and other state-of-the-art systems. FIG. 4A shows average packet latency for synthetic traffic patterns (e.g., bitreversal, transpose, butterfly, random) and normalized average packet latency for PARSEC applications using various systems (e.g., XY, DYAD, QR, BILCQ, CrQ, and exemplary system). FIG. 4A, subpanel (a) shows the exemplary system outperformed all other routing policies for bit-reversal, butterfly, and transpose traffic due to its path and region contention-aware cost configuration and shared path experience update mechanism. For random uniform traffic, BiLCQ performed better than the exemplary system, which can be attributed to the reverse path updates used by BiLCQ. As uniform random traffic utilized the reverse of each path with equal probability, the additional updates from BiLCQ ensured that about half the paths updated Q-values without any packets traversing those paths. Generally, Q-routing policies in the exemplary system outperformed XY and DyAD.

In FIG. 4A, subpanel (b), the results show the exemplary system achieved 18.3%, 15.7%, and 13.3% better packet latency than CrQ, QR, and BiLCQ, respectively. In contrast to synthetic traffic, the gap between XY, DyAD, and Q-routing policies was smaller. The drop in observed Q-routing performance is likely due to real application traffic not exhibiting the permanent patterns found in synthetic traffic, which can be learned by Q-routing methods. The study contemplates that experience sharing can accelerate learning for short-term patterns using additional updates.

While patterns in synthetic traffic were fixed, routing policies may readjust to changing traffic patterns over time. To test the adaptability under varying traffic patterns, the study set the traffic pattern to change after an interval of 100,000 cycles and monitored packet latency. FIG. 4B shows the average network latency for interval-wise synthetic traffic. The results for average packet latency in FIG. 4B demonstrate that exemplary system can sustain low packet latency even under varying traffic pattern scenarios.

Energy Results. FIG. 4C shows the total NoC energy consumed per packet for synthetic traffic and PARSEC applications across all routing methods. As shown, the exemplary system reduced total energy consumption per packet by 6.7%, 3.1%, and 2.3% compared to CrQ, QR, and BiLCQ, respectively. The exemplary system reduced total energy consumption by (i) using a low-power Q-routing cost calculation method (cost calculation of the exemplary system did not involve keeping track of queuing times of packets), (ii) providing lower precision Q-values by using a cost with a lower upper limit compared to packet latency, and (iii) reducing packet latency using better routing decisions.

Area Results. Table 1 shows the area overhead of each Q-routing method (e.g., QR, BiLCQ, CrQ, and exemplary system). The study minimized the area overhead in the exemplary system by (i) using lower precision Q-values, and (ii) reducing the computational overhead of computing the cost using contention-based metrics instead of tracking packet latency. The additional column for tracking routes had minimal overhead, and the total table area still grew linearly with core count.

TABLE 2

| | Area Overhead (μm²) | | | | |
|---|---|---|---|---|---|
| | | Q | | Cost | |
| Routing | Router | Table | % | Logic | % |
| QR | 0.0426 | 0.0021 | 5.07% | 0.00026 | 0.62% |
| BiLCQ | 0.0426 | 0.0046 | 10.98% | 0.00001 | 0.03% |
| CrQ | 0.0426 | 0.0046 | 10.97% | 0.00026 | 0.62% |
| Q-RASP | 0.0426 | 0.0024 | 5.67% | 0.00001 | 0.02% |

### Discussion

As manycore chips continue to integrate an increasing number of cores, network-on-chip (NoC) architectures have emerged as a solution to overcome data movement bottlenecks by providing improved scalability, performance, and reliability during communication [1]. Within NoCs, routing policies are key in determining the path packets take towards a destination. Traditional routing policies range from simple deterministic policies, such as dimension-order XY routing, which always chooses the same route for packets between a source and destination, to more complex adaptive congestion-aware reinforcement learning (RL) based policies, such as Q-routing [2].

Routing policies can be classified as oblivious or adaptive based on how routing decisions are made. Among other things, oblivious routing policies do not consider the current network state when selecting routing paths, e.g., XY routing, random walk routing, etc. In contrast, adaptive policies can consider runtime knowledge, such as network congestion information based on downstream router buffer occupancy, when selecting a routing path. Adaptive routing can perform better than oblivious routing when packet flows are non-uniform, i.e., when some nodes are over-represented in the communication traffic. In such cases, adaptive routing can better distribute traffic in the NoC to avoid congestion.

While adaptive policies can greedily select the least congested next hop, they lack information about congestion on the remaining path. The problem can be solved by communicating the global state of congestion in the NoC to every router, but such solutions scale poorly and incur excessive communication overhead. Q-routing [3] represents an alternative solution whereby the routing policy can form a global congestion estimate using information only from neighboring nodes. A NoC router is associated with each node in the network. The router maintains a table with congestion estimates for different destinations in the form of Q-values. Q-routing policies have been shown to improve NoC performance compared to other routing policies [3] due to their ability to learn from experience.

The performance of Q-routing policies depends on their (i) cost function, and (ii) update mechanism. The cost function defines how congestion is inferred from the network condition to assess the quality of a routing action, whereas the update mechanism establishes a methodology to use the experience of the routing agent (cost and estimates from neighbor nodes) to update the existing policy. In current state-of-the-art Q-routing methods, the cost can be slow to calculate or fail to represent congestion accurately. Further, update mechanisms used in previous methods fail to update the Q-values, resulting in underperforming Q-routing policies.

The study addressed these limitations by developing the exemplary Q-learning-based NoC routing system and method, also referred to as Q-RASP (Q-Routing for NoCs with Region-Awareness and Shared Path Experience). The exemplary system defines a path-and region-aware cost by prioritizing path contention over latency or input contention and augmenting it with a regional cost component. The exemplary system also shares learning updates between packet flows to different destinations which share the same route.

Additional Discussion. Previous studies minimized packet latency with Q-routing, so the cost functions, defined per previous studies, can include queue latency of the packet in the local router [2], [4], queue latency of the packet in the downstream router [5]-[7], and input buffer utilization of the downstream router [8], [9]. By selecting neighbors with the lowest expected latency or number of occupied input buffers, contention in the path to the destination is minimized, thus reducing latency.

A Q-routing policy may also ensure that the Q-values in the tables are frequently updated to reflect the most current state of the network. In the Q-routing algorithm, the update of Q-values (Equation 4) can be triggered by routing a packet through a router, but if packets are not frequently sent to a destination over some paths, the Q-values for those paths are not updated. Therefore, the routing table may represent an outdated state of the network, resulting in suboptimal routing decisions. To address the problem of outdated Q-values, previous studies developed different modifications to the update mechanism. In Bi-LCQ [3], data packets were appended with Q-value estimates to update the Q-values of the path in the reverse direction. In CrQ [6], a credence measure associated with Q-values was used to adjust the weight of each update. The value of credence is high for Q-values that have been updated recently. During the update step, the learning rate is increased for incoming Q-values with high credence.

There are several drawbacks with previous Q-routing implementations. For example, when local queue packet latency is used as the cost, it fails to use information from the downstream router for accurate estimates. When downstream packet latency is used, it is only available after the packet exits the downstream router. The delay in cost availability can reduce the learning speed, which can be avoided if the buffer status of the downstream router is used instead of queue latency. However, the packet also faces contention for the output port of the downstream router, which was not considered in previous studies. The update mechanism used by methods such as Bi-LCQ can additionally update the path in the reverse direction of a packet flow. However, the reverse flow may not exist in all traffic scenarios, and in such cases, the Q-values may never be used. Large variations in the learning rate in methods such as CrQ can lead to unstable learning, and the policy may never converge.

### Conclusion

The construction and arrangement of the systems and methods, as shown in the various implementations, are illustrative only. Although only a few implementations have been described in detail in this disclosure, many modifications are possible (e.g., variations in sizes, dimensions, structures, shapes, proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products, including machine-readable media for carrying or having machine-executable instructions or data structures stored thereon. Such machine-readable media can be any available media that can be accessed by a general-purpose or special-purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium; thus, any such connection is properly termed a machine-readable medium. Combinations of the above are also included within the scope of machine-readable media. Machine-executable instructions include, for example, instructions and data that cause a general-purpose computer, special-purpose computer, or special-purpose processing machine to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on the designer's choice. All such variations are within the scope of the disclosure. Likewise, software implementations could be accomplished with programming techniques with rule-based logic and other logic to accomplish the various connection steps, processing steps, comparison steps, and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.
[1] S. Pasricha et al., “On-Chip Communication Architectures”, Morgan Kauffman, ISBN 978-0-12-373892-9, April 2008.
[2] J. Boyan et al., “Packet Routing in Dynamically Changing Networks” in Advances in Neural Information Processing Systems, Morgan-Kaufmann, 1993.
[3] F. Farahnakian et al., “Bi-LCQ: A low-weight clustering-based Q-learning approach for NoCs,” Microprocess. Microsyst., vol. 38, no. 1, pp. 64-75, February 2014.
[4] Y. Gupta et al., “Reinforcement Learning based Routing for Cognitive Network on Chip,” in Proc. 2nd Inter. Conf. on ICTCS, New York, USA, Mar. 4-5, 2016.
[5] F. Farahnakian et al., “Q-learning based congestion-aware routing algorithm for on-chip network,” in IEEE 2nd Inter. Conf. on Networked Embedded Systems for Enterprise Applications, Perth, Australia, Dec. 8-9, 2011.
[6] N. Gupta et al., “Improved Route Selection Approaches using Q-learning framework for 2D NoCs,” in Proc. of the 3rd Inter. Workshop on Many-core Embedded Systems, New York, USA, Jun. 13-14, 2015.
[7] S. Srivastava et al., “Intelligent congestion control for NoC architecture in Gem5 simulator,” in IEEE 15th Inter. Symp. on Embedded Multicore/Many-core Systems-on-Chip, Penang, Malaysia, Dec. 19-22, 2022.
[8] H. Liu et al., “TTQR: A Traffic-and Thermal-Aware Q-Routing for 3D Network-on-Chip,” Sensors, vol. 22, no. 22, January 2022.
[9] Y. Liu et al., “A Q-Learning-Based Fault-Tolerant and Congestion-Aware Adaptive Routing Algorithm for Networks-on-Chip,” IEEE Embed. Syst. Lett., vol. 14, no. 4, pp. 203-206, December 2022.
[10] E. Taheri et al., “DeFT: A Deadlock-Free and Fault-Tolerant Routing Algorithm for 2.5D Chiplet Networks,” in DATE, Antwerp, Belgium, Mar. 14-23, 2022.
[11] S. Pasricha et al., “OE+IOE: a novel turn model based fault tolerant routing scheme for networks-on-chip,” in Proc. 8th IEEE/ACM/IFIP Inter. Conf. on Hardware/Software Codesign and System Synthesis, Scottsdale, USA, Oct. 24-29, 2010.
[12] V. Catania et al., “Cycle-Accurate Network on Chip Simulation with Noxim,” ACM Trans. Model. Comput. Simul., vol. 27, no. 1, p. 4:1-4:25, New York, USA, August 2016.
[13] A. B. Kahng et al., “ORION3.0: A Comprehensive NoC Router Estimation Tool,” IEEE Embed. Syst. Lett., vol. 7, no. 2, pp. 41-45, June 2015.
[14] J. Hu et al., “DyAD: smart routing for networks-on-chip,” in Proc. 41st Annu. Design Automation Conf. (DAC), New York, USA, Jun. 7-11, 2004.

What is claimed:

1. A network-on-chip (NoC) having a plurality of cores and a plurality of routers forming a fabric to connect the plurality of cores, the network-on-chip comprising:
at all or a substantial set of the plurality of routers, each router of the all or subset comprising:
a port having one or more input channels and one or more output channels;
a routing table configured to store a set of one or more Q-values each associated with an estimated congestion or delay cost for a network packet to traverse a flow defined between a neighbor router and a destination router, wherein the Q-values are determined from Q-values aggregated along all or a portion of the flow; and
a router processor unit having instructions stored thereon, wherein execution of the instructions causes the router processor unit to:
receive via the one or more input channels a network packet from another router in the NOC or generate a network packet from data received from a core connected to the router;
determine a route to send the network packet based on the set Q-values, wherein the determination is used to transmit the network packet along the flow to a subsequent router located downstream to the router; and
generate an update to at least one of the one or more Q-values using (i) a Q-value determined and stored at a respective routing table of a subsequent router, (ii) contention cost associated with congestion or occupied channels in a downstream router.

2. The network-on-chip of claim 1, wherein the contention cost includes path contention cost defined by a number of occupied input channels and output channels determined for the subsequent router.

3. The network-on-chip of claim 1, wherein the contention cost includes region contention cost determined as a sum of all valid port numbers of reserved output channels.

4. The network-on-chip of claim 1, wherein the subsequent router and all subsequent routers in the flow are configured to
determine an updated Q-value; and
update via a reinforcement learning operation one or more Q-values based on data received from a subsequent router to the each respective router.

5. The network-on-chip of claim 4, wherein the update to the Q-value employs Q-value determined and stored at a respective routing table of a subsequent router, and the contention cost associated with congestion or occupied channels in a downstream router.

6. The network-on-chip of claim 5, wherein the occupied channels in a downstream router is a determined as a number of occupied input and output channels determined and stored in a channel reservation table of the subsequent router.

7. The network-on-chip of claim 5, the update to the Q-value is performed in the router processor unit.

8. The network-on-chip of claim 1, wherein the operation to generate the update to the at least one of the one or more Q-values is performed using a reinforcement agent executing in each router of the NoC.

9. The network-on-chip of claim 5, the update to the Q-value is performed in part by the router processor unit and in part by a core operatively coupled to the router processor unit.

10. The network-on-chip of claim 1, wherein the routing table of the subsequent router maintains a route indicator to a respective destination router having a previously reached prior packet transmission.

11. The network-on-chip of claim 10, wherein the route indicator is an integer or encoded value representing a direction of a flow of the network packet to a port associated with the respective destination router.

12. The network-on-chip of claim 10, wherein the subsequent router is configured to additionally transmit (i) Q-values determined and stored at a respective routing table of other routers based on the route indicator and (ii) contention cost associated with congestion or occupied channels in a downstream router.

13. The network-on-chip of claim 2, wherein the path contention cost is determined using a path contention cost circuit implemented in the router, the path contention cost circuit comprising at least one of:
a comparator and adder configured to increment a partial sum for a total number of occupied input VCs and reserved output VC.

14. The network-on-chip of claim 3, wherein the region contention cost is determined using a region contention cost circuit implemented in the router, the region contention cost circuit comprising an adder configured to add the number of reserved VCs in the outputs other than the selected output downstream routers to the subsequent router.

15. A method comprising:
receiving data packet at a first router in a network-on-chip (NoC) having a plurality of cores and a plurality of routers forming a fabric to connect the plurality of cores;
determining a route between two or more neighbor routers to send the data packet based on a set Q-values associated with estimated path contention and region contention cost determined for the data packet being sent to a given neighbor router;
transmitting the data packet from the first router to a neighbor router based on the determination;
receiving at the first router updated cost parameters associated with the estimated path contention and the region contention cost from the neighbor router; and
updating at the first router one or more Q-values using updated cost parameters associated with the estimated path contention and the region contention cost from the neighbor router received from the neighbor router, wherein the updated Q-values are subsequently used to route subsequent data packet received at the first router.

16. The method of claim 15, wherein the set Q-values associated with estimated path contention and region contention cost are maintained in a Q-routing table.

17. The method of claim 15,
wherein the subsequent router is configured to receive the data packet and determine a route between two or more of its neighbor routers to send the data packet based on a set Q-values associated with estimated path contention and region contention cost determined for the data packet being sent to its neighboring routers,
wherein the subsequent router is configured to (i) receive updated cost parameters associated with the estimated path contention and the region contention cost from its neighbor router and (ii) update one or more Q-values of its Q-routing table using the updated cost parameters associated with the estimated path contention and the region contention cost received from its neighbor router.

18. The method of claim 15, wherein the subsequent router is configured to perform a shared path experience operation that additionally transmits (i) Q-values determined and stored at a respective routing table of other routers based on the route indicator and (ii) contention cost associated with congestion or occupied channels in a downstream router.

19. The method of claim 18, wherein the subsequent router is configured to update the route indicator in the routing table based on flow of other data packets.

20. A system comprising:
a plurality of cores and a plurality of routers, wherein all or a substantial set of the plurality of routers comprises:
a port having one or more input channels and one or more output channels;
a routing table configured to store a set of one or more Q-values each associated with an estimated congestion or delay cost for a network packet to traverse a flow defined between a neighbor router and a destination router, wherein the Q-values are determined from Q-values aggregated along all or a portion of the flow; and
a router processor unit having instructions stored thereon, wherein execution of the instructions causes the router processor unit to:
receive via the one or more input channels a network packet from another router in the NOC or generate a network packet from data received from a core connected to the router;
determine a route to send the network packet based on the set Q-values, wherein the determination is used to transmit the network packet along the flow to a subsequent router located downstream to the router; and
generate an update to at least one of the one or more Q-values using (i) a Q-value determined and stored at a respective routing table of a subsequent router, (ii) contention cost associated with congestion or occupied channels in a downstream router.
